(19) United States
(12) Patent Application Publication
(10) Pub. No.: US 2026/0331079 A1
(43) Pub. Date: Oct. 22, 2026

(54) Compression-Stabilized Multi-Shell Stringed Instrument Body

(71) Applicant: Jando, LLC d/b/a Cosmophonic Guitars, West Lake Hills, TX (US)

(72) Inventor: Olaf Reistrup, West Lake Hills, TX (US)

(73) Assignee: Jando, LLC d/b/a Cosmophonic Guitars, West Lake Hills, TX (US)

(21) Appl. No.: 19/643,309

(22) Filed: Apr. 9, 2026

Related U.S. Application Data
(60) Provisional application No. 63/790,650, filed on Apr. 17, 2025.
(60) Provisional application No. 63/839,896, filed on Jul. 7, 2025.
(60) Provisional application No. 63/983,168, filed on Feb. 14, 2026.

(51) Int. Cl. G10D 1/08; G10D 3/04; G10D 3/06

(52) U.S. Cl. CPC G10D 1/085; G10D 3/02

(57) ABSTRACT

A compression-stabilized multi-shell body for a stringed musical instrument. The body includes a first outer shell and a second outer shell separated by an intermediate structural core. Each outer shell includes a perimeter region surrounding an interior facing surface that cooperates with the opposing shell. One or more fasteners extend through the shells and the structural core to mechanically couple the components and place the body assembly under compressive preload. A centrally located fastener and perimeter located fasteners maintain compressive engagement between the shells and the structural core. The structural core functions as a load-bearing member that distributes structural loads through the body assembly. A neck of the instrument may be secured to the body so that string tension forces are transmitted into the compression-stabilized structure. The architecture improves rigidity and load distribution while reducing body mass.

### PRIORITY STATEMENT UNDER 35 U.S.C. § 119 & 37 C.F.R. § 1.78

The present application claims priority from and incorporates by reference U.S. Provisional Patent Application Ser. No. 63/790,650 filed Apr. 17, 2025 titled “Modular Electric Guitar with Replaceable Perimeter Grill, Integrated Strap Track, and Adjustable Scale Length”; U.S. Provisional Patent Application Ser. No. 63/839,896 filed Jul. 7, 2025 titled “Tilt Marquise Electric Guitar Pickup”; and U.S. Provisional Patent Application Ser. No. 63/983,168 filed Feb. 14, 2026 titled “Endur-O-Flex Top Coat Finishing System”, all of which are incorporated by reference herein.

### TECHNICAL FIELD

The present invention relates generally to stringed musical instruments and, more particularly, to body architectures and structural systems for guitars, bass guitars, and related instruments that improve structural load distribution, acoustic behavior, modularity, and durability.

### BACKGROUND OF THE INVENTION

Stringed musical instruments such as electric guitars commonly employ body structures formed from a single solid block of wood or from permanently laminated layers of material. While such monolithic constructions have been widely used for decades, they present several structural and functional limitations. The present disclosure addresses improvements in instrument body construction, acoustic airflow management, strap attachment structures, scale-length adaptability, and pickup sensing architectures.

In conventional guitar bodies formed from a single body blank or from permanently laminated layers that function as a unified structural mass, structural loads generated by string tension, neck attachment, and bridge mounting are concentrated within a relatively limited region of the body material. Because these loads are often supported by threaded fasteners embedded directly into wood, localized stresses may develop that can contribute to deformation, material fatigue, or loosening of structural components over time. Additionally, monolithic body constructions often require relatively large volumes of material in order to achieve sufficient rigidity, which may increase the overall weight of the instrument.

Accordingly, there exists a need for an instrument body architecture capable of distributing structural loads more efficiently while reducing overall body mass and maintaining structural rigidity.

Many stringed instruments include internal cavities or partially hollow structures intended to influence acoustic resonance or reduce weight. However, conventional instrument bodies often rely on fixed sound holes or permanently formed cavities that cannot be easily modified or tuned. In many designs, airflow between internal cavities and the surrounding environment is limited or unevenly distributed, which may result in localized pressure zones, undesirable resonance peaks, or inconsistent acoustic response. Furthermore, the perimeter regions of conventional instrument bodies typically serve only structural or cosmetic functions and do not contribute meaningfully to airflow control or acoustic tuning.

Accordingly, there exists a need for a structural element capable of both enclosing the perimeter cavity of a multi-shell instrument body and permitting controlled airflow that may influence acoustic behavior.

Moreover, conventional strap attachment mechanisms for guitars typically consist of a strap button secured to the instrument body by a single threaded fastener. While widely used, this arrangement concentrates the entire weight of the instrument on a single screw embedded within the body material. Over time, repeated loading, vibration, and movement may enlarge the screw hole or weaken the surrounding material. In some cases, the strap button may loosen or detach from the instrument body, potentially causing the instrument to fall. Additionally, conventional strap attachment systems do not distribute loads across a broader structural region of the instrument body.

Accordingly, there exists a need for a strap engagement system capable of distributing strap loads over a larger structural footprint within the instrument body while providing a secure yet easily detachable connection.

Another shortcoming of conventional stringed instruments is that they are generally designed for a fixed scale length determined by the distance between the bridge and the nut of the instrument. Different scale lengths are associated with different tonal characteristics, string tension profiles, and playability preferences. Because the bridge position is typically fixed relative to the body of the instrument, musicians wishing to use different scale lengths generally require separate instruments designed specifically for each scale configuration. Existing designs rarely allow simple reconfiguration of the bridge position relative to the neck without permanent structural modifications to the instrument body.

Accordingly, there exists a need for a bridge mounting arrangement that allows the effective scale length of the instrument to be modified in a reversible way without altering the structural integrity of the instrument body.

In addition to the foregoing, electric guitar pickups typically employ magnetic pole pieces positioned beneath the instrument strings in order to detect string vibration and convert it into an electrical signal. Conventional pickup designs often rely on uniform cylindrical pole pieces or bar magnets positioned beneath the strings. While such designs are widely used, they may produce uneven string response, magnetic interference between adjacent sensing elements, or tonal artifacts resulting from overlapping magnetic fields. In particular, when multiple magnetic sensing structures interact within the same pickup assembly latitudinally, magnetic crossover effects may occur, potentially degrading signal clarity or producing undesirable tonal characteristics. Conversely, variations in magnetic interaction along the longitudinal axis of each string may influence tonal characteristics, including phasing or chorusing effects.

Accordingly, there exists a need for a pickup architecture that improves magnetic sensing of string vibration while reducing latitudinal interference between adjacent strings and magnetic sensing structures.

The present disclosure provides improvements addressing the foregoing issues through a compression-stabilized multi-shell instrument body construction together with structural and functional features including a removable perimeter vent element, a longitudinal rail channel strap system, a repositionable scale-length bridge assembly, and an improved magnetic pickup architecture.

### SUMMARY OF THE INVENTION

The present invention relates to structural architectures for stringed musical instruments and, more particularly, to body constructions that improve structural load distribution, rigidity, modularity, and durability.

In one embodiment, the invention provides a compression-stabilized multi-shell instrument body. The body includes a first outer shell, a second outer shell, and an intermediate structural core positioned between the shells. Each outer shell includes a perimeter region surrounding an interior region. When assembled, the perimeter regions cooperate to define an outer structural boundary of the instrument body while the interior regions define the interior area.

The intermediate structural core extends between the shells and functions as a load-bearing structural member within the body. One or more fasteners extend through the body to mechanically couple the shells and the structural core together. In certain embodiments, a centrally located fastener and a plurality of perimeter located fasteners place the shells and structural core under compressive preload, thereby forming a compression-stabilized multi-shell structure.

The compression-stabilized architecture distributes structural loads through the shells and the structural core rather than concentrating loads in localized regions of the body material. The structural arrangement also increases the effective engagement length of load-bearing fasteners and improves resistance to forces generated by string tension and instrument use.

In certain embodiments, a neck of the stringed instrument is secured to the multi-shell body assembly using neck fasteners that extend through the body structure and engage the structural core. Loads generated by string tension may therefore be transmitted through the neck and distributed into the compression-stabilized body assembly.

In another embodiment, the invention provides a removable vent element positioned along at least a portion of the perimeter interface between the outer shells. The vent element may extend longitudinally along the boundary between the shells and may include apertures that permit airflow between the internal body cavity and the surrounding environment. In certain embodiments, the vent element may also function as a structural element bridging the perimeter regions of the shells.

In another embodiment, the invention provides a longitudinal rail channel system integrated into the instrument body. The rail channel system extends along a portion of the body and receives a strap-mounted engagement member that may be inserted through an entry opening and guided along a channel within the rail. A retention mechanism, such as a magnet or other retention device at the end of the track, may be provided to prevent unintended disengagement of the engagement member from the rail. Because the rail may be secured to the structural core, loads applied through the strap attachment may be distributed through the body structure rather than concentrated at a single attachment point.

The instrument may further include a repositionable scale-length assembly configured to selectively alter the effective scale length of the instrument without modification to the underlying body structure. In one embodiment, a bridge mounting plate is secured to the instrument body at fixed mounting locations and supports a bridge positioned in an offset relationship relative to a longitudinal centerline of the mounting plate. The bridge is oriented at a predetermined angle relative to the longitudinal axis of the instrument to provide proper string intonation. The mounting plate is configured to be rotated, such as by approximately 180 degrees, while utilizing the same fixed mounting locations, thereby repositioning the bridge longitudinally relative to the neck. This repositioning enables the instrument to be selectively configured for different scale lengths while maintaining the same mounting footprint and preserving the angular orientation of the bridge relative to the strings.

In a further embodiment, the invention provides a pickup assembly positioned within a pickup housing mounted to the instrument body. The pickup assembly may include magnetic pole elements having differing geometries and adjustable pole elements that interact with a magnetic field to detect vibration of instrument strings. In certain embodiments, the magnetic sensing elements may be arranged to reduce magnetic crossover interference between adjacent sensing regions.

The structural architecture described herein allows multiple functional subsystems, including structural load transfer, airflow interaction with the internal body cavity, strap load distribution, bridge mounting, and pickup sensing systems, to be integrated within a coordinated multi-shell body construction.

Various embodiments may implement one or more of these structural features individually or in combination. Additional variations and configurations consistent with the principles described herein will become apparent from the detailed description that follows.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function.

FIG. 1A is an interior view of an embodiment of a first outer shell of a compression-stabilized multi-shell stringed instrument body;

FIG. 1B is an interior view of an embodiment of a second outer shell of a compression-stabilized multi-shell stringed instrument body;

FIG. 2 is a bottom view of the compression-stabilized multi-shell body structure illustrating the relationship between the first outer shell, the second outer shell, the intermediate structural core, and the perimeter located fasteners;

FIG. 3 is another interior view of a first outer shell illustrating the attachment of a guitar neck to the compression-stabilized multi-shell body assembly through neck fasteners;

FIG. 4 is a perspective view illustrating a removable vent element positioned along a perimeter interface between the outer shells of the instrument body;

FIG. 5 is a partial structural view illustrating the internal arrangement of the compression-stabilized multi-shell body and the placement of the removable vent element along the perimeter boundary of the body;

FIG. 6 is an isolated view of an embodiment of the removable vent element;

FIG. 7 is a perspective view illustrating the removable vent element installed between the outer shells along the perimeter of the instrument body;

FIG. 8 is a perspective view illustrating an embodiment of a longitudinal rail channel system integrated into the instrument body;

FIG. 9 is a perspective view illustrating insertion of a strap-mounted button into the longitudinal rail channel system;

FIG. 10 is a perspective view illustrating engagement of the strap-mounted button within the longitudinal rail channel system and interaction with a retention mechanism;

FIG. 11A is a top view of the instrument body illustrating the bridge mounting plate in a first orientation;

FIG. 11B is a schematic view illustrating rotation of the bridge mounting plate relative to the instrument body;

FIG. 11C is a top view of the instrument body illustrating the bridge mounting plate in a second orientation after rotation, wherein a bridge is repositioned longitudinally relative to a neck of the instrument;

FIG. 12 is a perspective view illustrating an embodiment of a guitar pickup assembly within a pickup housing;

FIG. 13 is a schematic view illustrating the relative positioning of marquise-shaped magnetic pole pieces and adjustable screw poles within the pickup assembly;

FIG. 14 is a schematic view illustrating magnetic field interaction within the pickup assembly; and

FIG. 15 is a schematic view illustrating spatial separation of latitudinal magnetic sensing elements within the pickup assembly to reduce magnetic crossover interference.

### DETAILED DESCRIPTION

Before explaining the various embodiments of the presently disclosed invention in detail, it is to be understood that the presently disclosed invention is not limited in its application to the details of construction and the arrangement of the components or steps or methodologies set forth in the following description. The presently disclosed invention is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed invention shall have meanings that are commonly understood by those of ordinary skill in the art. Further, unless otherwise required by context, singular terms shall include pluralities and plural terms shall include the singular.

All of the systems and methods disclosed herein can be made and executed without undue experimentation in light of the present disclosure. While the systems and methods of the presently disclosed invention have been described in terms of preferred embodiments, it will be apparent to those of skill in the art that variations may be applied to the systems or methods and in the steps or in the sequence of steps of the method described herein without departing from the concept, spirit, and scope of the presently disclosed invention. All such similar substitutes and modifications apparent to those skilled in the art are deemed to be within the spirit, scope, and concept of the presently disclosed invention.

### 1. Compression-stabilized Multi-shell Construction

The present invention relates generally to stringed musical instruments and, more particularly, to structural body architectures for instruments such as electric guitars employing a compression-stabilized multi-shell construction.

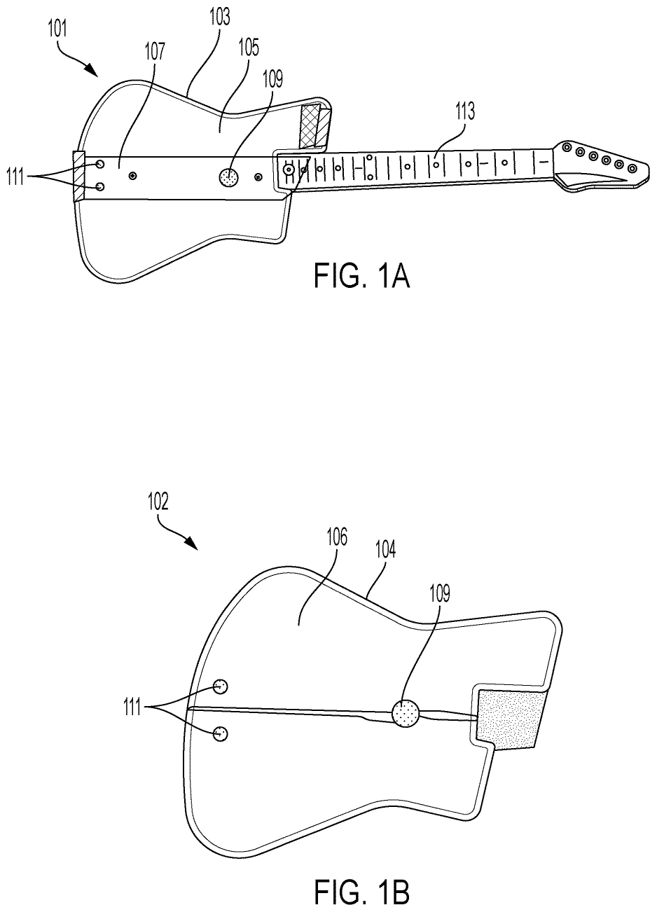

Referring to FIG. 1A-3, the instrument body comprises a first outer shell 101, a second outer shell 102, and an intermediate structural core 107 disposed between the first outer shell 101 and the second outer shell 102.

Unlike conventional guitar bodies formed from a single monolithic body blank or permanently laminated layers, the first outer shell 101, the second outer shell 102, and the intermediate structural core 107 are physically discrete components that are mechanically coupled together to form the body of the instrument.

Each outer shell 101, 102 includes an interior-facing surface 105, 106 that may be generally planar, contoured, recessed, or otherwise shaped to achieve desired structural, acoustic, and manufacturing characteristics. In certain embodiments, the interior-facing surface 105, 106 may be substantially flat, such that the internal cavity is defined primarily by the thickness and geometry of the intermediate structural core 107 separating the first outer shell 101 from the second outer shell 102. In other embodiments, one or both of the outer shells 101, 102 may include recessed or scalloped interior regions that remove material from the interior-facing surfaces 105, 106 to reduce weight, alter resonance characteristics, or modify stiffness profiles of the body.

The spacing between the first outer shell 101 and the second outer shell 102 is established by the intermediate structural core 107, which maintains separation between the shells and defines at least a portion of the internal cavity. In embodiments incorporating interior facing surfaces 105, 106 that are recessed or scalloped, the internal cavity may be further expanded beyond the thickness of the intermediate structural core 107. In embodiments employing generally planar interior-facing surfaces 105, 106, the internal cavity may be more uniform in cross-section and defined substantially by the geometry of the intermediate structural core 107.

Regardless of the specific interior geometry, the first outer shell 101, the second outer shell 102, and the intermediate structural core 107 cooperate to form a multi-shell body structure in which the internal cavity is bounded by the opposing interior-facing surfaces 105, 106, of the outer shells and the intervening structural core. This arrangement allows the interior geometry of the shells to be selectively configured to balance weight reduction, structural rigidity, acoustic response, and manufacturability without altering the fundamental compression-stabilized coupling of the multi-shell assembly.

Positioned between the first outer shell 101 and the second outer shell 102 is the intermediate structural core 107. The intermediate structural core 107 extends longitudinally within the body and functions as a load-bearing structural member.

As shown in FIGS. 1A and 3, the intermediate structural core 107 occupies a central region between the interior facing surface 105 of the first outer shell 101 and the interior facing surface 106 of the second outer shell 102. The intermediate structural core 107 may be formed from wood, metal, composite material, engineered structural materials, or combinations thereof.

The intermediate structural core 107 transfers structural loads between the first outer shell 101 and the second outer shell 102 and provides a structural interface for attachment of other instrument components.

A centrally located fastener 109 extends through the body structure to mechanically couple the first outer shell 101, the intermediate structural core 107, and the second outer shell 102. The centrally located fastener 109 applies compressive force through the body thickness and thereby stabilizes the multi-shell structure.

In addition to the centrally located fastener 109, a plurality of perimeter located fasteners 111 extend through the first outer shell 101 and into the intermediate structural core 107 or through both shells in order to further secure the assembly. The perimeter located fasteners 111 are positioned at spaced locations around the body and cooperate with the centrally located fastener 109 to maintain compressive coupling between the first outer shell 101, the second outer shell 102, and the intermediate structural core 107.

The centrally located fastener 109 and the perimeter located fasteners 111 collectively produce a compression-stabilized body structure in which the outer shells and the intermediate structural core 107 are held together under compressive preload. This compression distributes structural forces across the multi-shell assembly and increases the structural rigidity of the instrument body.

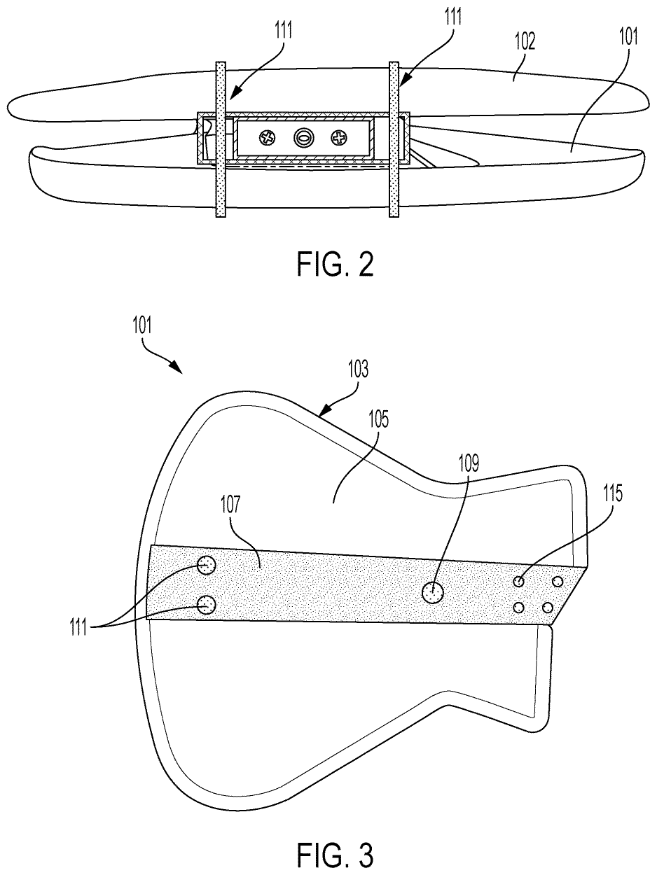

Referring to FIG. 2, the first outer shell 101 and the second outer shell 102 are spaced apart by the intermediate structural core 107, creating a body geometry that is functionally analogous to an I-beam-like structure in cross-section. In this configuration, the intermediate structural core 107 functions as a central load-bearing member while the first outer shell 101 and the second outer shell 102 function as opposing structural flanges.

This structural relationship allows bending and torsional loads applied to the instrument body to be distributed efficiently across the multi-shell structure.

The interior facing surface 105 of the first outer shell 101 and the interior facing surface 106 of the second outer shell 102 may be scalloped to reduce material usage and weight while preserving structural strength through the perimeter regions 103 and 104.

As shown in FIGS. 1A and 3, the instrument further includes a guitar neck 113 extending from the body. The guitar neck 113 is secured to the multi-shell body assembly through a plurality of neck fasteners 115. The neck fasteners 115 pass through the body structure and secure the guitar neck 113 to the assembled structure formed by the first outer shell 101, the second outer shell 102, and the intermediate structural core 107.

The neck fasteners 115 therefore transmit forces from the guitar neck 113 into the compression-stabilized body assembly, allowing structural loads generated by string tension and player interaction to be distributed through the intermediate structural core 107 and the outer shells.

The compression-stabilized multi-shell construction described herein provides several advantages relative to conventional monolithic guitar body constructions.

First, the use of physically discrete outer shells and a central structural core allows structural loads to be distributed more efficiently through the body structure.

Second, the compression produced by the centrally located fastener 109 and the perimeter located fasteners 111 increases rigidity of the body and reduces deformation caused by string tension or environmental changes.

Third, the interior facing surface 105 of the first outer shell 101 and the interior facing surface 106 of the second outer shell 102 in embodiments where scalloping is used, the interior-facing surfaces 105, 106 may be configured to reduce overall weight while maintaining structural integrity through the perimeter regions 103 and 104.

Finally, the multi-shell construction allows the structural and acoustic properties of the first outer shell 101, the second outer shell 102, and the intermediate structural core 107 to be independently optimized through material selection and geometry.

### 2. Removable Vent Element

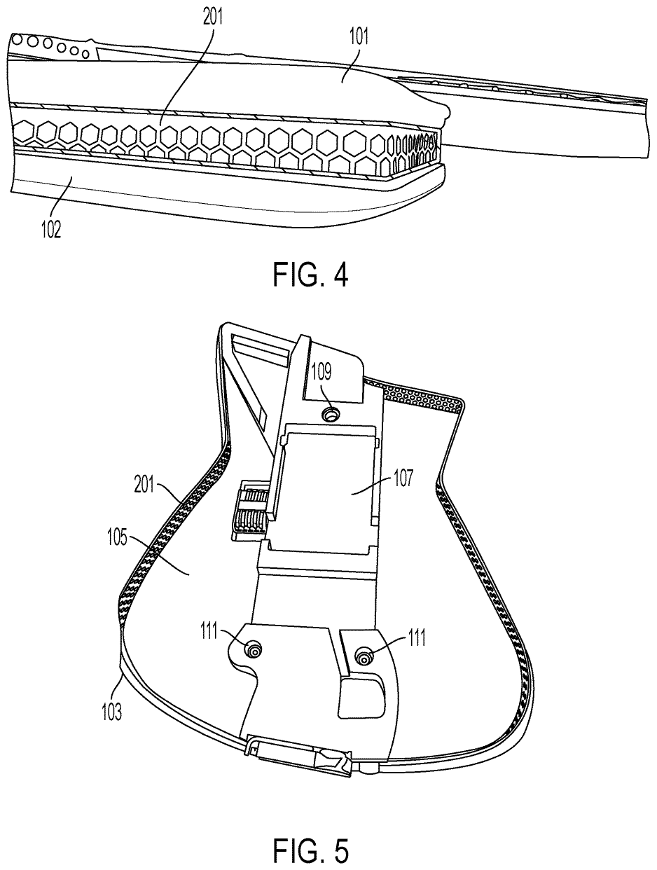

Referring now specifically to FIG. 4, a removable vent element 201 is positioned along at least a portion of the perimeter interface between the first outer shell 101 and the second outer shell 102. The removable vent element 201 extends longitudinally along the body perimeter and bridges the gap between the perimeter region 103 of the first outer shell 101 and the perimeter region 104 of the second outer shell 102. The removable vent element 201 may include a contoured profile corresponding to the perimeter geometry of the instrument body.

In the embodiment shown in FIG. 4, the removable vent element 201 comprises a perforated structure positioned between the outer shells. The removable vent element 201 may be formed from metal, composite materials, polymer structures, or other rigid materials capable of maintaining structural integrity while permitting airflow through the openings.

The removable vent element 201 encloses the cavity formed between the interior facing surface 105 of the first outer shell 101 and the interior facing surface 106 of the second outer shell 102 while permitting air exchange between the internal cavity and the surrounding environment. The removable vent element 201 may include a plurality of apertures arranged in a pattern that extends along the perimeter of the instrument body.

FIG. 5 illustrates the internal arrangement of the compression-stabilized multi-shell body structure. In this figure, the intermediate structural core 107 is positioned between the first outer shell 101 and the second outer shell 102, with the centrally located fastener 109 extending through the body structure. Perimeter located fasteners 111 secure the shells and the intermediate structural core 107 together at spaced locations.

The removable vent element 201 is positioned along the perimeter interface between the perimeter region 103 of the first outer shell 101 and the perimeter region 104 of the second outer shell 102. The removable vent element 201 therefore functions as a perimeter structural element that closes the body cavity while permitting airflow through the vent openings.

In the embodiment shown, the guitar neck 113 extends from the body and is secured to the assembled shell and core structure by neck fasteners 115. The neck fasteners 115 secure the guitar neck 113 to the body structure formed by the first outer shell 101, the second outer shell 102, and the intermediate structural core 107.

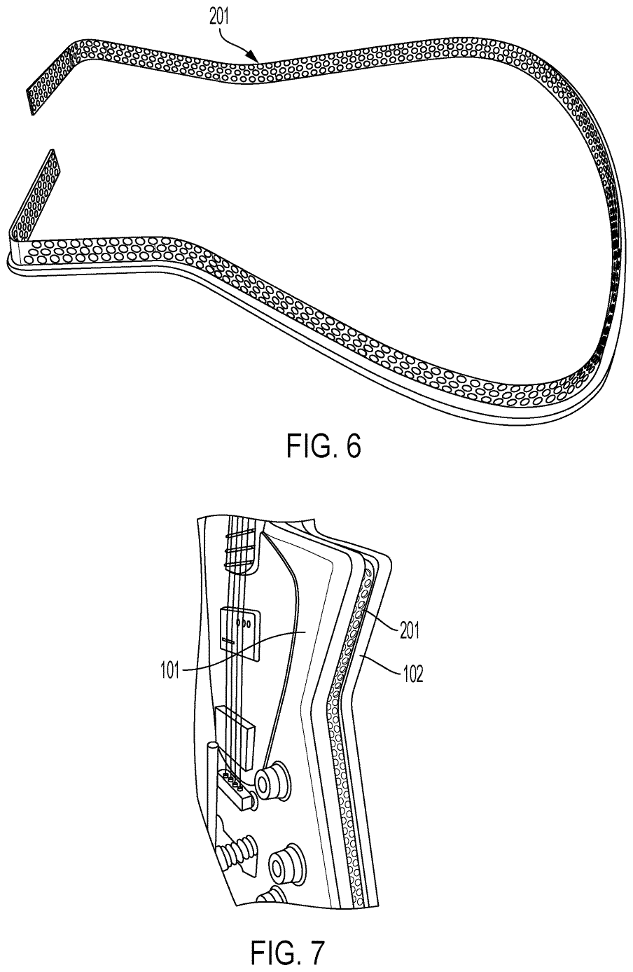

Referring now to FIG. 6, the removable vent element 201 is shown independently of the instrument body. In this embodiment, the removable vent element 201 is an elongated perimeter component shaped to correspond to the outer boundary of the instrument body.

The removable vent element 201 includes a series of perforations extending along its length. These perforations may be circular, hexagonal, slot-shaped, rectangular, or otherwise patterned openings. The removable vent element 201 may be fabricated from aluminum, steel, brass, titanium, wood, composite materials, or polymer materials depending on the desired structural and acoustic properties.

Because the removable vent element 201 is detachable from the body structure, different vent elements may be installed to alter airflow characteristics, acoustic behavior, or aesthetic appearance of the instrument.

FIG. 7 illustrates the removable vent element 201 installed between the first outer shell 101 and the second outer shell 102 along the perimeter of the instrument body. In this configuration, the removable vent element 201 forms a boundary between the shells while allowing air to pass between the internal cavity and the surrounding environment.

The removable vent element 201 may be inserted into a channel formed along the perimeter region 103 of the first outer shell 101 and the perimeter region 104 of the second outer shell 102, or otherwise secured between the shells during assembly.

In addition to allowing airflow through the body cavity, the removable vent element 201 also functions as a perimeter structural reinforcement between the first outer shell 101 and the second outer shell 102.

The incorporation of the removable vent element 201 into the compression-stabilized multi-shell construction provides several advantages.

First, the removable vent element 201 encloses the internal cavity formed between the interior facing surface 105 of the first outer shell 101 and the interior facing surface 106 of the second outer shell 102 while permitting airflow through the body.

Second, the removable vent element 201 reinforces the structural boundary formed by the perimeter region 103 of the first outer shell 101 and the perimeter region 104 of the second outer shell 102.

Third, because the removable vent element 201 is detachable, different vent configurations may be installed to modify acoustic characteristics, airflow behavior, or aesthetic properties of the instrument body.

Finally, the removable vent element 201 cooperates with the compression-stabilized structure formed by the centrally located fastener 109, the perimeter located fasteners 111, and the intermediate structural core 107 to maintain rigidity and structural integrity of the multi-shell body assembly.

### 3. Longitudinal Rail Channel System

Referring now specifically to FIG. 8, a longitudinal rail channel system 301 is integrated into the body of the instrument. The longitudinal rail channel system 301 extends along a portion of the instrument body and is positioned between the first outer shell 101 and the second outer shell 102. The longitudinal rail channel system 301 may be secured to or supported by the intermediate structural core 107 so that loads applied to the rail channel system 301 are transferred into the structural core.

The longitudinal rail channel system 301 includes an elongated channel 305 extending along its length. The channel 305 is configured to receive and guide a strap-mounted button 309 during engagement with the rail channel system 301.

An entry point to the channel 305 is defined by a notched hole 303 formed along the rail structure. The notched hole 303 permits the button 309 to be inserted into the channel 305 from outside the instrument body. Once inserted through the notched hole 303, the button 309 may slide longitudinally within the channel 305.

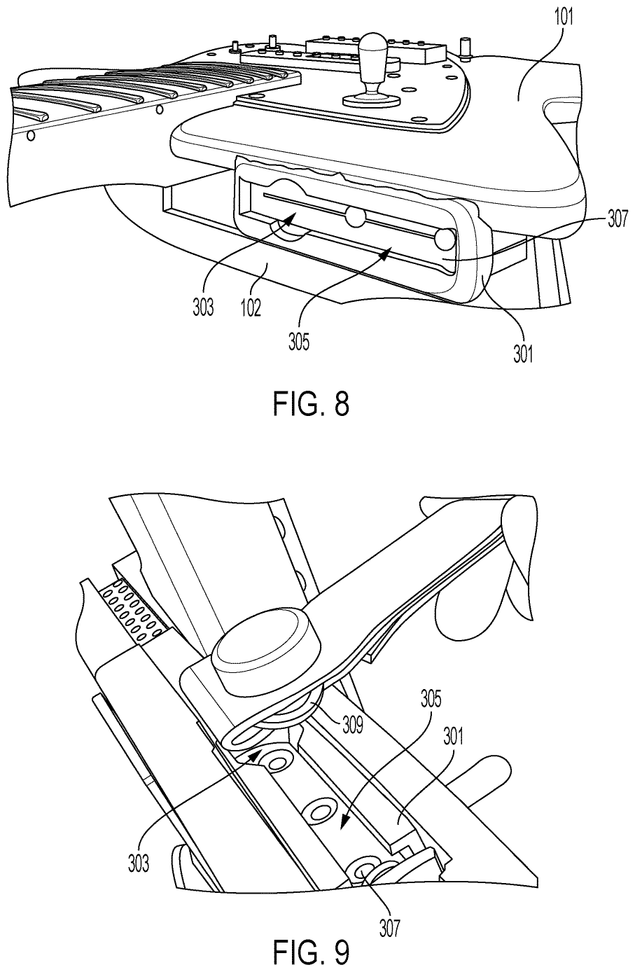

Referring now to FIG. 9, the interaction between the button 309 and the longitudinal rail channel system 301 is illustrated in greater detail. The button 309 is inserted through the notched hole 303 and positioned within the channel 305 of the longitudinal rail channel system 301. Once positioned within the channel 305, the button 309 may slide along the channel until it engages a catch system 307, such as a magnet or spring-loaded ball catch, positioned along the rail channel system 301. The catch system 307 is configured to prevent unintended removal of the button 309 from the channel 305 during use.

In certain embodiments, the catch system 307 may comprise a spring-loaded ball detent, a magnetic retention element, a mechanical latch, or other retention structure capable of preventing unintended movement of the button 309 out of the channel 305. The catch system 307 allows the button 309 to be inserted through the notched hole 303 and moved along the channel 305 while resisting removal unless a deliberate release force is applied. The longitudinal rail channel system 301 therefore distributes loads applied through the button 309 along the length of the rail rather than concentrating the load at a single attachment point.

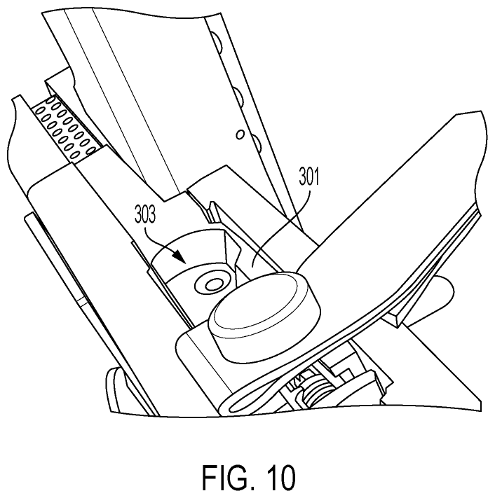

FIG. 10 illustrates the button 309 engaged within the channel 305 of the longitudinal rail channel system 301 during use. In this configuration, the button 309 is retained within the channel 305 by the surrounding rail structure and the catch system 307. The notched hole 303 provides an entry location through which the button 309 may be inserted into the channel 305, while the catch system 307 prevents unintended disengagement of the button 309 once it is positioned within the rail channel system 301.

Loads applied to the button 309 during use are transferred into the longitudinal rail channel system 301 and from there into the instrument body through the intermediate structural core 107 and the compression-stabilized assembly formed by the first outer shell 101, the second outer shell 102, the centrally located fastener 109, and the perimeter located fasteners 111.

The integration of the longitudinal rail channel system 301 into the compression-stabilized multi-shell construction allows external loads applied through the button 309 to be transferred into the structural core of the instrument body rather than being supported solely by the material of the outer shells.

The structural load path extends from the button 309 through the channel 305 of the longitudinal rail channel system 301 into the intermediate structural core 107 and through the compression-stabilized assembly defined by the centrally located fastener 109 and the perimeter located fasteners 111 securing the first outer shell 101 and the second outer shell 102.

This configuration distributes loads more efficiently across the body structure and reduces the likelihood of localized structural failure at a single attachment point.

The longitudinal rail channel system 301 incorporated into the compression-stabilized multi-shell body provides several advantages over conventional strap attachment methods.

First, the rail system distributes loads applied through the button 309 along the length of the channel 305 rather than concentrating loads at a single fastener location.

Second, the catch system 307 provides a retention mechanism that prevents accidental disengagement of the button 309 from the rail channel system 301.

Third, the notched hole 303 allows convenient insertion and removal of the button 309 while maintaining secure engagement during use.

Finally, because the longitudinal rail channel system 301 is integrated into the compression-stabilized multi-shell structure formed by the first outer shell 101, the second outer shell 102, the intermediate structural core 107, the centrally located fastener 109, and the perimeter located fasteners 111, loads applied through the rail are transferred efficiently through the instrument body.

### 4. Repositionable Scale-length Assembly.

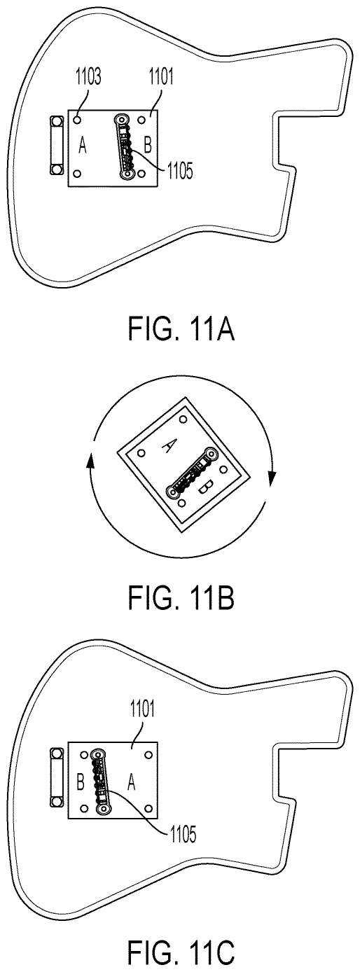

Referring now to FIG. 11A-11C, a repositionable scale-length assembly is illustrated in connection with the compression-stabilized multi-shell instrument body.

As shown in FIG. 11A, a bridge mounting plate 1101 is positioned on the exterior surface of the instrument body and is configured to support a bridge assembly. The bridge mounting plate 1101 comprises a substantially planar member, which in one embodiment is formed of a rigid material such as metal, and is secured to the instrument body using a plurality of mounting fasteners positioned at fixed locations 1105. The mounting fasteners 1105 define a consistent attachment footprint on the instrument body, permitting repeatable installation of the bridge mounting plate 1101 without modification to the underlying structure.

The bridge is mounted to the bridge mounting plate 1101 in an offset position relative to a longitudinal centerline of the bridge mounting plate 1101. As illustrated in FIG. 11A, the bridge is positioned such that its centerline is displaced from the longitudinal centerline of the bridge mounting plate 1101 by a predetermined offset distance. In one embodiment, this offset distance is approximately 0.375 inches.

The bridge is further mounted at a predetermined angular orientation relative to the longitudinal axis of the instrument, as represented by the angled bridge position 1103, in order to provide proper string intonation across the strings.

Referring now to FIG. 11B, the bridge mounting plate 1101 is configured to be selectively rotated relative to the instrument body. In particular, the bridge mounting plate 1101 may be rotated approximately 180 degrees while maintaining the same mounting fastener locations 1105. This rotational capability allows the bridge mounting plate 1101 to be repositioned without altering the attachment points in the instrument body.

Referring now to FIG. 11C, the bridge mounting plate 1101 is shown in a rotated orientation relative to FIG. 11A. Due to the offset mounting of the bridge on the bridge mounting plate 1101, rotation of the bridge mounting plate 1101 results in a longitudinal repositioning of the bridge relative to the neck of the instrument.

In one embodiment, rotation of the bridge mounting plate 1101 by approximately 180 degrees repositions the bridge by approximately 0.375 inches along the longitudinal axis of the instrument, or another offset sufficient to position multiple scale configurations within the adjustment range of the bridge saddles. This repositioning allows the instrument to be selectively configured for different scale lengths, such as a first configuration corresponding to a scale length of approximately 24.75 inches and a second configuration corresponding to a scale length of approximately 25.5 inches.

In practice, the displacement of the bridge is selected such that each scale-length configuration falls within the available intonation adjustment range of the bridge saddles. Because conventional bridge saddles provide a limited range of longitudinal adjustment, the displacement need not equal the full difference between theoretical scale lengths. Instead, a reduced offset, such as approximately 0.375 inches, allows both configurations to be accurately intonated within the available saddle travel. In certain implementations, the selected offset may further account for variations in neck geometry, including the distance between a neck pocket and a nut, as well as differences in bridge saddle geometry or available adjustment range, while still positioning multiple scale-length configurations within the usable intonation range of the bridge assembly.

Importantly, the angular orientation of the bridge relative to the strings, as defined by the angled bridge position 1103, remains unchanged in both rotational configurations of the bridge mounting plate 1101. As a result, proper string intonation is preserved regardless of the selected scale length.

In both configurations shown in FIGS. 11A and 11C, the bridge mounting plate 1101 is secured to the instrument body using the same fixed mounting fastener locations 1105. Accordingly, conversion between scale length configurations does not require relocation, redrilling, or modification of the mounting fasteners 1105 or the instrument body.

Scale length conversion is therefore accomplished by rotating the bridge mounting plate 1101 and installing a corresponding neck configured for the selected scale length, while maintaining the structural integrity of the compression-stabilized multi-shell instrument body.

### 5. Guitar Pickup Assembly

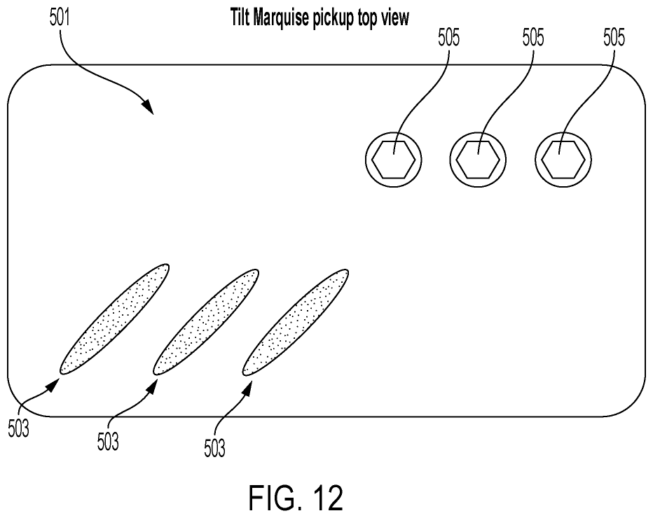

Referring now specifically to FIG. 12, an electric guitar pickup assembly is illustrated positioned within a pickup housing 501. The pickup housing 501 is configured to be mounted to the instrument body and positioned beneath the strings of the instrument so that vibrations of the strings may be detected by the pickup assembly.

The pickup housing 501 encloses the magnetic sensing components of the pickup system and may be mounted to the first outer shell 101 or to a mounting structure supported by the intermediate structural core 107.

Within the pickup housing 501 are a plurality of marquise-shaped pieces 503 positioned beneath selected strings of the instrument. The marquise-shaped pieces 503 function as magnetic pole elements that interact with a magnetic field 507 produced within the pickup assembly.

In the embodiment illustrated in FIG. 12, the marquise-shaped pieces 503 are positioned beneath the bass-side strings of the instrument and are oriented at an angle relative to the string direction. Each marquise-shaped piece 503 has a geometry in which a central portion of the element is wider and gradually tapers toward narrower ends.

This geometry allows the marquise-shaped pieces 503 to produce a graduated magnetic interaction with the vibrating string across the width of the string's vibration envelope. The tapered geometry of the marquise-shaped pieces 503 therefore provides a magnetic field interaction that varies along the string width, which may improve detection of string vibration and reduce undesirable magnetic pull on the strings.

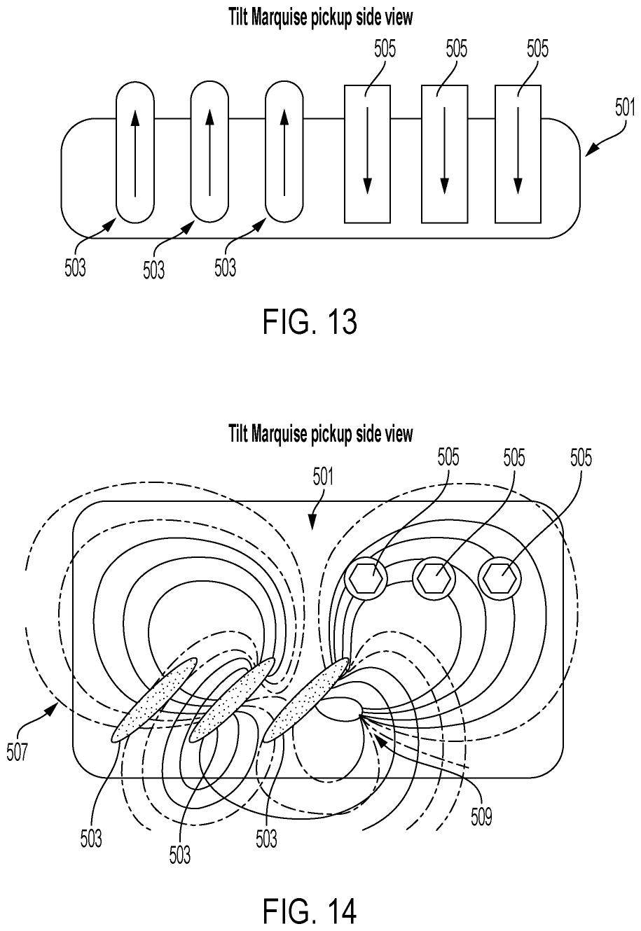

Referring now to FIG. 13, the pickup housing 501 in some embodiments further includes adjustable screw poles 505 positioned beneath additional strings of the instrument. The adjustable screw poles 505 are positioned within the pickup housing 501 so that their vertical position relative to the strings may be adjusted. This adjustment allows the magnetic interaction between the pickup assembly and individual strings to be tuned by the user.

Each adjustable screw pole 505 may be threaded within the pickup housing 501 so that rotation of the screw pole changes its height relative to the strings. Adjusting the height of the adjustable screw poles 505 allows the output level of individual strings to be balanced. The marquise-shaped pieces 503 and the adjustable screw poles 505 are positioned within the pickup housing 501 so that each interacts with the magnetic field 507 produced by the pickup assembly.

Referring now to FIG. 14, the magnetic field 507 produced within the pickup housing 501 interacts with the marquise-shaped pieces 503 and the adjustable screw poles 505. The magnetic field 507 extends upward toward the vibrating strings of the instrument and varies in intensity depending on the geometry and orientation of the magnetic elements within the pickup housing 501. Because the marquise-shaped pieces 503 taper toward their ends, the magnetic field 507 produced in the vicinity of each marquise-shaped piece 503 varies across the width of the vibrating string path. This variation allows the pickup system to capture string vibration across a broader sensing region.

The adjustable screw poles 505 provide localized magnetic field interaction with individual strings. By adjusting the vertical position of the adjustable screw poles 505, a user may adjust the strength of the magnetic field 507 at the location of a particular string. This adjustment allows the pickup assembly to produce balanced output across multiple strings even when the strings differ in diameter, tension, or vibration amplitude.

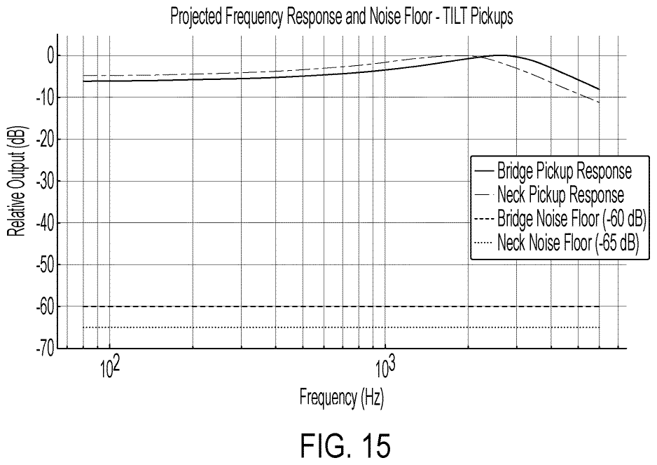

Referring now to FIG. 15, the spatial relationship between the marquise-shaped pieces 503 and the adjustable screw poles 505 within the pickup housing 501 is illustrated. In this configuration, the marquise-shaped pieces 503 and the adjustable screw poles 505 are positioned in separate regions of the pickup housing 501 so that each interacts with the vibrating strings in a distinct magnetic sensing region.

This spatial separation reduces the likelihood of magnetic crossover interference 509 that can occur when multiple magnetic sensing elements interact with the same region of the vibrating string. Crossover interference 509 may occur when magnetic fields generated by adjacent pole elements interact in undesirable ways, potentially causing phase distortion or tonal artifacts in the pickup signal between adjacent strings (latitudinally), while potentially enhancing magnetic field interaction along the longitudinal extent of a given string between opposing ends of the same magnetic element. By separating the marquise-shaped pieces 503 from the adjustable screw poles 505 within the pickup housing 501, the pickup system may reduce magnetic crossover interference 509 and allows each magnetic sensing element to interact more independently with the vibrating strings.

The spatial separation of the marquise-shaped pieces 503 and the adjustable screw poles 505 therefore produces a more stable magnetic field 507 and improves clarity of the electrical signal generated by the pickup assembly.

The pickup housing 501 is mounted to the instrument body so that string vibrations are transmitted to the pickup assembly while the structural integrity of the instrument body is maintained by the compression-stabilized multi-shell construction. The pickup housing 501 may be mounted to the first outer shell 101 or to a mounting structure supported by the intermediate structural core 107 so that the pickup assembly remains structurally stable relative to the strings.

Because the body structure is stabilized by the centrally located fastener 109 and the perimeter located fasteners 111 securing the first outer shell 101, the second outer shell 102, and the intermediate structural core 107 together, vibrations transmitted through the instrument body are controlled and predictable.

The guitar neck 113 remains secured to the body through neck fasteners 115, allowing string vibration forces to be transmitted through the neck and into the compression-stabilized body structure.

The rigid and stable structure formed by the first outer shell 101, the second outer shell 102, the intermediate structural core 107, the centrally located fastener 109, and the perimeter located fasteners 111 provides a stable mounting environment for the pickup housing 501 and contributes to consistent sensing of string vibration.

The pickup system illustrated in FIG. 12-15 provides several functional advantages when integrated with the compression-stabilized multi-shell instrument body.

First, the marquise-shaped pieces 503 provide a magnetic sensing geometry that interacts with vibrating strings across a wider sensing region, which may improve tonal clarity and string response.

Second, the adjustable screw poles 505 allow individual adjustment of the magnetic interaction with each string, permitting the pickup assembly to be tuned for balanced output.

Third, the spatial separation of the marquise-shaped pieces 503 and the adjustable screw poles 505 may reduce magnetic crossover interference 509 within the magnetic field 507, thereby improving signal clarity and reducing tonal artifacts.

Finally, integration of the pickup housing 501 with the compression-stabilized multi-shell body architecture allows the pickup assembly to operate within a structurally rigid instrument body formed by the first outer shell 101, the second outer shell 102, the intermediate structural core 107, the centrally located fastener 109, and the perimeter located fasteners 111.

While the present system and method have been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may refer to the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for those multiple embodiments.

In light of the wide variety of methods for constructing stringed musical instruments known in the art, the detailed embodiments are intended to be illustrative only and should not be taken as limiting the scope of the invention. Rather, what is claimed as the invention is all such modifications as may come within the spirit and scope of the following claims and equivalents thereto.

None of the descriptions in this specification should be read as implying that any particular element, step or function is an essential element which must be included in the claim scope. The scope of the patented subject matter is defined only by the allowed claims and their equivalents. Unless explicitly recited, other embodiments of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

In the claims:

1. A stringed musical instrument comprising:
a body comprising
a first outer shell,
a second outer shell spaced from the first outer shell, and
an intermediate structural core positioned between the first outer shell and the second outer shell;
at least one fastener extending through the first outer shell, the intermediate structural core, and the second outer shell;
wherein tightening of the fastener places the first outer shell and the second outer shell in compressive engagement with the intermediate structural core to form a compression-stabilized multi-shell body structure that distributes structural loads through the structural core and the outer shells.

2. The stringed musical instrument of claim 1 wherein the first outer shell comprises a perimeter region surrounding an interior facing surface.

3. The stringed musical instrument of claim 1 wherein the second outer shell comprises a perimeter region surrounding an interior facing surface.

4. The stringed musical instrument of claim 1 wherein the first outer shell and the second outer shell define the body.

5. The stringed musical instrument of claim 1 wherein the intermediate structural core extends longitudinally within the body.

6. The stringed musical instrument of claim 1 wherein the intermediate structural core functions as a load-bearing structural member.

7. The stringed musical instrument of claim 1, wherein the at least one fastener comprises a centrally located fastener.

8. The stringed musical instrument of claim 1 further comprising perimeter located fasteners positioned around the body.

9. A stringed musical instrument comprising:
a body including
a first outer shell,
a second outer shell spaced from the first outer shell, and
an intermediate structural core positioned between the shells;
at least one fastener extending through the first outer shell, the intermediate structural core, and the second outer shell;
wherein tightening of the at least one fastener places the shells in compressive engagement with the structural core such that the structural core functions as a load-bearing web member and the outer shells function as opposing flange members of a beam-like structural assembly that distributes loads through the body.

10. The stringed musical instrument of claim 9 wherein the intermediate structural core extends longitudinally within the body.

11. The stringed musical instrument of claim 9 further comprising a neck extending from the body.

12. The stringed musical instrument of claim 9 wherein the neck is secured to the body by neck fasteners.

13. The stringed musical instrument of claim 9 wherein the neck fasteners engage the intermediate structural core.

14. A stringed musical instrument comprising:
a compression-stabilized multi-shell body including
a first outer shell,
a second outer shell spaced from the first outer shell,
an intermediate structural core positioned between the shells, and
fasteners extending through the shells and the structural core to place the shells in compressive engagement with the structural core; and
a removable vent element positioned between perimeter regions of the first outer shell and the second outer shell;
wherein the removable vent element permits airflow between an internal cavity defined between the shells and an exterior environment.

15. The stringed musical instrument of claim 14 wherein the removable vent element extends along a perimeter interface between the shells.

16. The stringed musical instrument of claim 14 wherein the removable vent element comprises a perforated structure.

17. A stringed musical instrument comprising:
a body;
a neck coupled to the body;
a bridge mounting plate secured to the body at a plurality of fixed mounting locations; and
a bridge supported by the bridge mounting plate,
wherein the bridge is positioned in an offset relationship relative to a longitudinal centerline of the bridge mounting plate.

18. The stringed musical instrument of claim 17 wherein the bridge is oriented at a predetermined angle relative to a longitudinal axis of the instrument to provide string intonation.

19. The stringed musical instrument of claim 17 wherein the bridge mounting plate is configured to be selectively rotated relative to the body while remaining secured at the plurality of fixed mounting locations, such that rotation of the bridge mounting plate repositions the bridge longitudinally relative to the neck.

20. The stringed musical instrument of claim 17 wherein rotation of the bridge mounting plate by approximately 180 degrees repositions the bridge to provide a different scale length configuration while maintaining an angular orientation of the bridge relative to strings of the instrument and without requiring relocation of the plurality of fixed mounting locations.
